(19) United States
(12) Patent Application Publication
(10) Pub. No.: US 2019/0200550 A1
(43) Pub. Date: Jul. 4, 2019

(54) MEDIA

(71) Applicants: Victor Andrew HEATH, Newcastle under Lyme (GB); Michael John TOFT, Newcastle under Lyme (GB); Craig John TOFT, Newcastle under Lyme (GB)

(72) Inventors: Michael John TOFT, Newcastle under Lyme (GB); Craig John TOFT, Newcastle under Lyme (GB)

(73) Assignees: Victor Andrew HEATH, Newcastle under Lyme (GB); Michael John TOFT, Newcastle under Lyme (GB); Craig John TOFT, Newcastle under Lyme (GB)

(21) Appl. No.: 16/331,520

(22) PCT Filed: Aug. 25, 2017
(86) PCT No.: PCT/GB2017/052503

§ 371 Date: Mar. 7, 2019

(30) Foreign Application Priority Data
Sep. 8, 2016 (GB) 1615253.0

(51) Int. Cl. A01G 31/00; A01G 24/00

(52) U.S. Cl. CPC A01G 31/00; A01G 24/00

(57) ABSTRACT

A method of making a media usable for instance in hydroponics. The method comprising mixing together three components, granulating the mixture and firing the granules formed, the first component is silica sand, the second component is mica granite sand, and the third component is a glass powder, with the firing taking place at a temperature such that the third component melts during firing.

This invention concerns a media and a method of making a media, and particularly but not exclusively a media usable in hydroponics, aquaponics, or water filtration.

A number of media have been proposed for use in hydroponics and/or aquaponics. A commonly used such media is baked clay pellets. In general in most instances it is not possible, or at least not advisable, to clean and reuse such media. Media can be used in a wide range of situations and processes, and can be used for instance in water filtration.

According to a first aspect of the invention there is provided a method of making a media, the method comprising mixing together three components, granulating the mixture and firing the granules formed, the first component is silica sand, the second component is mica granite sand, and the third component is a glass powder, with the firing taking place at a temperature such that the third component melts during firing.

The three components may be provided in substantially equal portions by weight to each other.

The first component may include at least 70% silica.

The first component may include at least 1-5% alumina.

The first component may include at least 13% soda.

Additional trace elements may be added to the first component.

The first component may have a substantially uniform particle size, and may have a significantly more uniform particle size than the second component.

The first component may have a particle size of between 0.15 and 0.3 mm. The first component may be formed from waste glass.

The second component may have a relatively wide particle size distribution. The second component may have a particle size of substantially between 0.075 mm and 5 mm.

At least 95% of the second component may have a particle size of substantially between 0.075 mm and 5 mm.

At least 25% of the second component may have a particle size of greater than 1.0 mm.

At least 25% of the second component may have a particle size of less than 0.15 mm.

The third component may be soda lime glass.

The third component may have a particle size of less than 0.07 mm.

The third component may be formed of recycled glass, and may be formed of recycled windscreen glass.

The third component may have a melting point of less than 750° C., and may have a melting point of less than 740° C., and may have a melting point of around 710° C.

The components of the material may be mixed together in a blade mixer.

The mixture may be granulated in a granulator so as to produce balls of a required size.

Alternatively a granulating or pelletising mixer may be used to mix the components and provide balls of a required size.

The balls may have a diameter of between 10 and 15 mm.

The mixture may be fired to a maximum temperature of greater than 700° C., and may be fired to a maximum temperature of substantially 740° C.

The granulated mixture may be fired in a multi zone belt kiln.

According to a further aspect of the invention there is provided a media material made by a method according to any of the preceding twenty three paragraphs.

An embodiment of the present invention will now be described by way of example only:

The following components were added together and mixed in a blade type mixer till visibly evenly mixed, which may take for instance around 10 minutes.

The mixture comprises a first component of glass sand with a typical particle size of between 0.15 and 0.3 mm. This sand is formed from waste green container glass. The mixture also included a second component in the form of a mica granite sand containing sub angular grains of quartz, white feldspar and white mica. The mica granite sand has a relatively wide particle distribution, with particle sizes between 0.075 mm and 5 mm. The mixture also included a combustible organic product in the form of fine grade sawdust. A typical mix of this material would comprise:

30 kg silica sand powder

30 kg mica granite sand

30 kg glass powder

The mixed power is fed into a pan granulation machine and combined with a fine spray of water to form balls. When the balls reach a required size, which may differ between different applications, the balls fall from the pan into a container or onto a belt. The balls are fired in a four zone electric conveyor kiln at temperatures of 150° C., 400° C., 700° C. and 740° C., with a total travel time through the kiln of around 35 minutes. At least at the maximum firing temperature the glass powder melts to bond together the other components.

The finished product is a highly porous ball, typically with a porosity of around 40%. This contains roughly spherical particles of quartz and sand containing trace elements which have been shown to be beneficial to plant and aquatic life, whilst allowing maximum uptake of air and water through the media to the plants.

The finished product has the following major components:

| Component | Weight % |
|---|---|
| Silica (SiO₂ | 85.59 |
| Titania (TiO₂) | 0.03 |
| Alumina (Al₂O₃) | 3.28 |
| Ferric oxide (Fe₂O₃) | 0.20 |
| Lime (CaO) | 3.09 |
| Magnesia (MgO) | 1.36 |
| Potash (K₂O) | 1.14 |
| Soda (Na₂O) | 4.64 |
| Phosphorous Pentoxide (P₂O₅) | 0.04 |
| Chromium Sesquioxide (Cr₂O₃) | <0.01 |
| Manganic Oxide (Mn₃O₄) | <0.01 |
| Zirconia (ZrO₂) | 0.02 |
| Hafnia (HfO₂) | <0.01 |
| Lead Monoxide (PbO) | 0.05 |
| Zinc Oxide (ZnO) | <0.01 |
| Barium Oxide (BaO) | 0.01 |
| Strontia (SrO) | <0.01 |
| Stannic Oxide (SnO₂) | <0.01 |
| Cupric Oxide (CuO) | <0.01 |

Provided below is an indication of the wide particle size distribution of the mica granite sand, indicating the percentage retained by each sieve size.

| Sieve Size mm | % Retained |
|---|---|
| 5.0 | 2% |
| 2.36 | 2% |
| 1.18 | 25% |
| 0.6 | 15% |
| 0.3 | 17% |
| 0.15 | 30% |
| 0.075 | 9% |
| <0.075 | 2% |

It is to be realised that a wide range of modifications may be made without departing from the scope of the invention. For instance different materials as covered by the application may be mixed together. Different relative proportions of the three components may be provided. For instance examples with a relatively high proportion of mica granite sand, and a relatively low proportion of silica sand have been found to work well. A different firing pattern or technique could be used. Different mixing and/or granulation processes could be carried out. Additional trace elements may be incorporated in the media, as may be required or be advantageous to plant growth.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1.-20. (canceled)

21. A method of making a media, the method comprising:
mixing together a plurality of components into a mixture, the plurality of components including a first component that comprises silica sand, a second component that comprises mica granite sand, and a third component that comprises glass powder;
granulating the mixture to form granules; and
firing the granules formed, wherein the firing takes place at a temperature such that the third component melts during firing.

22. The method according to claim 21, wherein the plurality of components are provided in substantially equal portions by weight to each other.

23. The method according to claim 21, wherein the first component includes one or more of: at least 70% silica, at least 1-5% alumina, or at least 13% soda.

24. The method according to claim 21, further comprising adding additional trace elements to the first component.

25. The method according to claim 21, wherein the first component has a substantially uniform particle size.

26. The method according to claim 21, wherein the first component has a significantly more uniform particle size than the second component.

27. The method according to claim 21, wherein the first component has a particle size of between 0.15 and 0.3 mm.

28. The method according to claim 21, wherein the first component is formed from waste glass.

29. The method according to claim 21, wherein the second component has a relatively wide particle size distribution.

30. The method according to claim 21, wherein the second component has a particle size of substantially between 0.075 mm and 5 mm.

31. The method according to claim 21, wherein at least 25% of the second component has a particle size of greater than 1.0 mm.

32. The method according to claim 21, wherein the third component comprises one or more of soda lime glass, recycled glass, or recycled windscreen glass.

33. The method according to claim 21, wherein the third component has a particle size of less than 0.07 mm.

34. The method according to claim 21, wherein the third component has a melting point of less than 750° C.

35. The method according to claim 21, wherein the mixing includes mixing the plurality of components of the media together in a blade mixer.

36. The method according to claim 21, wherein the granulating includes granulating the mixture in a granulator so as to produce balls of a required size.

37. The method according to claim 21, wherein the granulating includes granulating the mixture in a granulating or pelletising mixer to mix the plurality of components and provide balls of a required size.

38. The method according to claim 21, wherein the firing includes firing the mixture to a maximum temperature of greater than 700° C.

39. The method according to claim 21, wherein the firing includes firing the granules in a multi zone belt kiln.

40. A media material, comprising:
a first component that includes silica sand;
a second component that includes mica granite sand; and
a third component that includes glass powder, wherein the third component melts at a temperature used for firing a granulated mixture that is formed from mixing together and granulating the first, second, and third components, in which the firing produces the media material.
